(19) United States
(12) Patent Application Publication
(10) Pub. No.: US 2018/0184364 A1
(43) Pub. Date: Jun. 28, 2018

(54) ENVIRONMENT SIGNATURES

(71) Applicant: BandwidthX Inc., Carlsbad, CA (US)

(72) Inventor: Chris VAN HAMERSVELD, San Marcos, CA (US)

(21) Appl. No.: 15/848,603

(22) Filed: Dec. 20, 2017

Related U.S. Application Data
(60) Provisional application No. 62/439,410, filed on Dec. 27, 2016.

(51) Int. Cl. H04W 48/16; H04L 29/12; H04W 12/08; H04L 29/06

(52) U.S. Cl. CPC H04W 48/16; H04L 61/1541; H04W 48/06; H04L 63/10; H04L 61/3075; H04W 12/08

(57) ABSTRACT

Systems, methods, and media for automated discovery of amenities using environment signatures. In an embodiment, one or more environment signatures are received from a server application. A radio system is used to scan an environment of the mobile device to determine visible access point identifier(s). For each of the one or more visible access point identifiers, a signature is computed from the visible access point identifier, and the computed signature is compared to each of the one or more environment signatures.

### CROSS-REFERENCE TO RELATED APPLICATIONS

The present application claims priority to U.S. Provisional Patent App. No. 62/439,410, filed on Dec. 27, 2016, which is hereby incorporated herein by reference as if set forth in full.

### BACKGROUND

### Field of the Invention

The embodiments described herein are generally directed to automated discovery of amenities (e.g., hotspots), by a mobile device, using environment signatures.

### Description of the Related Art

In mobile devices with multiple radio systems (e.g., a cellular radio system and a Wi-Fi™ radio system), there is currently a need to manage the secondary radio system (e.g., the Wi-Fi™ radio system) to find as many offload opportunities as possible, without requiring excessive data downloads or excessive manual work to curate, local, single-location amenity hotspots (e.g., provided by a local restaurant or boutique). In addition, a balance must be struck between the benefits of additional offload of traffic from a cellular network to a Wi-Fi™ network and the risk of the mobile device connecting to a nefarious hotspot that places the user's data at risk.

### SUMMARY

Accordingly, systems, methods, and media are disclosed for automated discovery of amenities, using environment signatures, to strike an appropriate balance between the tradeoffs discussed above.

In an embodiment, a method is disclosed for a mobile device comprising a first radio system and a second radio system. The method comprises using at least one hardware processor of the mobile device to: receive one or more environment signatures from a server application; use the second radio system to scan an environment of the mobile device to determine one or more visible access point identifiers; and, for each of the one or more visible access point identifiers, compute a signature from the visible access point identifier, and compare the computed signature to each of the one or more environment signatures. The method may be embodied in executable software modules of a processor-based system, such as a mobile device, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processed described herein, may be executed, according to an embodiment;

FIGS. 3A and 3B illustrate timings for a process of using environment signatures, according to alternative embodiments; and

FIG. 4 illustrates a process of comparing access point identifiers to environment signatures, according to an embodiment.

### DETAILED DESCRIPTION

In an embodiment, systems, methods, and non-transitory computer-readable media are disclosed for automated discovery of amenities using environment signatures. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

1. System Overview

1.1. Infrastructure

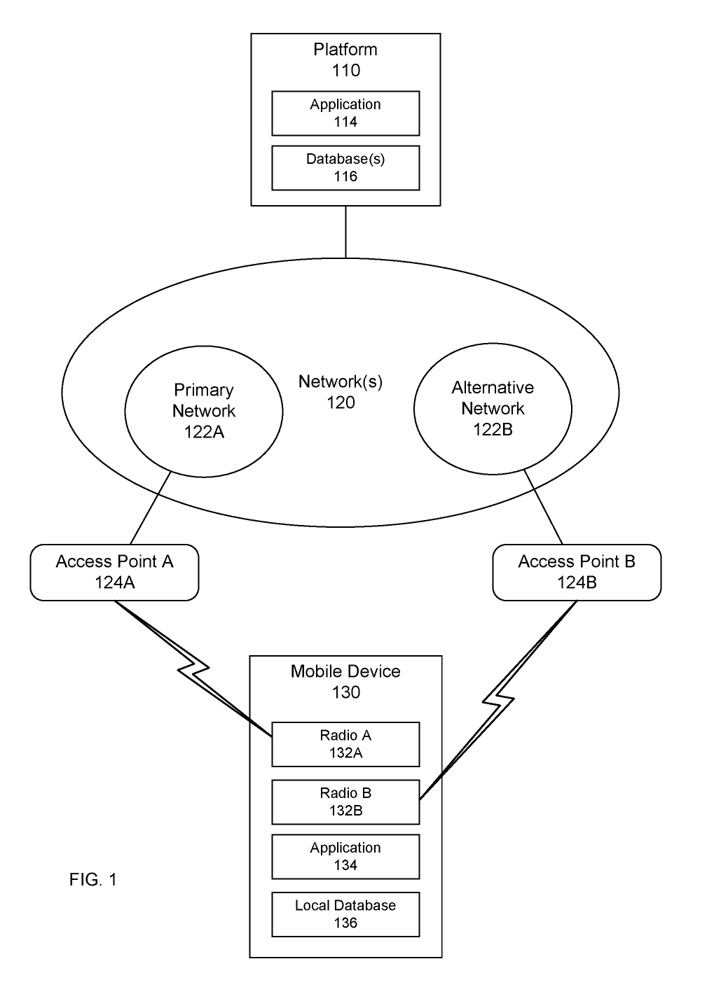

FIG. 1 illustrates an example system in which automated discovery of amenities may occur, according to an embodiment. The infrastructure may comprise a platform 110 (e.g., one or more servers) which hosts and/or executes one or more of the various functions, processes, methods, and/or software modules described herein. Platform 110 may comprise or be communicatively connected to a server application 114 and/or one or more databases 116. Platform 110 may comprise dedicated servers, or, alternatively, cloud instances which utilize shared resources of one or more servers. Platform 110 may comprise collocated and/or distributed servers or cloud instances. While only one server application 114 and one set of database(s) 116 are illustrated, it should be understood that the infrastructure may comprise any number of server applications and databases. Platform 110 may be communicatively connected to one or more mobile devices 130 via one or more networks 120.

Network(s) 120 may comprise the Internet, wireless communication networks, local home networks, any other network, and/or any combination of networks. As illustrated, network(s) 120 comprise or are communicatively connected to a primary network 122A and an alternative network 122B. In an embodiment, each of primary network 122A and alternative network 122B comprises a wireless communication network which communicates with a radio of mobile device(s) 130 via a wireless communication protocol. For example, primary network 122A may comprise a cellular network which utilizes 2G (e.g., GSM, GPRS, EDGE, iDEN, TDMA, CDMA), 3G (e.g., CDMA2000, 1×-EVDO, WCDMA, UMTS, HSPA), 4G (e.g., LTE, LTE-A), 5G, etc., whereas alternative network 122B may comprise a Wi-Fi™ network (e.g., one or more of the family of 802.11 standards from The Institute of Electrical and Electronic Engineers (IEEE)).

Mobile device(s) 130 may comprise any type or types of computing devices capable of wireless communication, including without limitation, desktop computers, laptop computers, tablet computers, smart phones or other mobile phones, servers, game consoles, televisions, set-top boxes, electronic kiosks, point-of-sale terminals, Automated Teller Machines, and the like. In an embodiment, each mobile device 130 comprises a first radio system 132A, a second radio system 132B, a client application 134, and a local database 136. Mobile device 130 may be configured to turn on or off one or both of the first and second radio systems 132A and 132B independently of each other. First radio system 132A uses a first wireless communication protocol (e.g., a protocol used for a cellular network) to wirelessly connect to an access point 124A (e.g., a cellular base station serving a sector of a cellular network), which provides access to primary network 122A. Second radio system 132B uses a second wireless communication protocol (e.g., Wi-Fi™) to wirelessly connect to an access point 124B (e.g., a Wi-Fi™ access point), which provides access to alternative network 122B. It should be understood that the first wireless communication protocol may be different from the second wireless communication protocol.

As used herein, the term “application” may refer to any executable software module or library of software modules that exists on platform 110 (e.g., as server application 114), mobile device 130 (e.g., as client application 134), or both platform 110 and mobile device 130 (e.g., with some functions executed, as modules of server application 114, on platform 110, and some functions executed, as modules of client application 134, on mobile device 130).

Any of the software modules or other components described herein may take a variety of forms. For example, a component may be a stand-alone software package, or it may be a software package incorporated as a “tool” in a larger software product. It may be downloadable from a network (e.g., from a website) as a stand-alone product or as an add-in package for installation in an existing software application or operating system. It may also be available as a client-server software application, as a web-enabled software application, and/or as a mobile application.

1.2. Example Processing Device

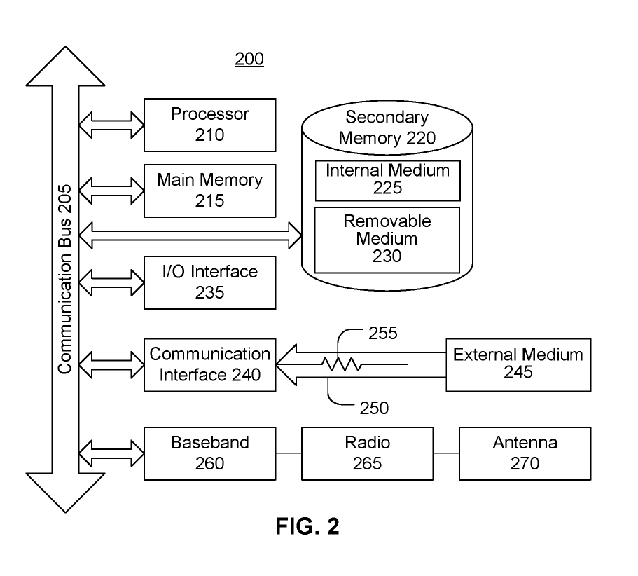

FIG. 2 is a block diagram illustrating an example wired or wireless system 200 that may be used in connection with various embodiments described herein. For example system 200 may be used as or in conjunction with one or more of the mechanisms, processes, methods, or functions (e.g., to store and/or execute the application or one or more software modules of the application) described herein, and may represent components of platform 110, mobile device(s) 130, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors, such as processor 210. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 210. Examples of processors which may be used with system 200 include, without limitation, the Pentium® processor, Core i7® processor, and Xeon® processor, all of which are available from Intel Corporation of Santa Clara, Calif.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

System 200 preferably includes a main memory 215 and may also include a secondary memory 220. Main memory 215 provides storage of instructions and data for programs executing on processor 210, such as one or more of the functions and/or modules discussed above. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal memory 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, etc.

Removable storage medium 230 is a non-transitory computer-readable medium having stored thereon computer-executable code (e.g., disclosed software modules) and/or data. The computer software or data stored on removable storage medium 230 is read into system 200 for execution by processor 210.

In alternative embodiments, secondary memory 220 may include other similar means for allowing computer programs or other data or instructions to be loaded into system 200. Such means may include, for example, an external storage medium 245 and a communication interface 240, which allows software and data to be transferred from external storage medium 245 to system 200. Examples of external storage medium 245 may include an external hard disk drive, an external optical drive, an external magneto-optical drive, etc. Other examples of secondary memory 220 may include semiconductor-based memory such as programmable read-only memory (PROM), erasable programmable read-only memory (EPROM), electrically erasable read-only memory (EEPROM), or flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 200 with a network or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network, or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (i.e., computer programs, such as the disclosed application, or software modules) is stored in main memory 215 and/or the secondary memory 220. Computer programs can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code (e.g., software and computer programs) to system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable mediums are means for providing executable code, programming instructions, and software to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform the features and functions described elsewhere herein.

In an embodiment, I/O interface 235 provides an interface between one or more components of system 200 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and the like.

System 200 may also include optional wireless communication components that facilitate wireless communication over a voice network and/or a data network. The wireless communication components comprise an antenna system 270, a radio system 265, and a baseband system 260. In system 200, radio frequency (RF) signals are transmitted and received over the air by antenna system 270 under the management of radio system 265.

In one embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also codes the digital signals for transmission and generates a baseband transmit audio signal that is routed to the modulator portion of radio system 265. The modulator mixes the baseband transmit audio signal with an RF carrier signal generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor 210, which may be a central processing unit (CPU). Processor 210 has access to data storage areas 215 and 220. Processor 210 is preferably configured to execute instructions (i.e., computer programs, such as the disclosed application, or software modules) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions of the disclosed embodiments. For example, data storage areas 215 or 220 may include various software modules.

2. Process Overview

Embodiments of processes for automated discovery of amenities will now be described in detail. It should be understood that the described processes may be embodied in one or more software modules that are executed by one or more hardware processors, e.g., as the application discussed above (e.g., server application 112, client application 134, and/or a distributed application comprising both server application 112 and client application 134), which may be executed wholly by processor(s) of platform 110, wholly by processor(s) of mobile device(s) 130, or may be distributed across platform 110 and mobile device(s) 130 such that some portions or modules of the application are executed by platform 110 and other portions or modules of the application are executed by mobile device(s) 130. The described process may be implemented as instructions represented in source code, object code, and/or machine code. These instructions may be executed directly by the hardware processor(s), or alternatively, may be executed by a virtual machine operating between the object code and the hardware processors. In addition, the disclosed application may be built upon or interfaced with one or more existing systems.

In an embodiment, any set of one or more of the processes described herein may be implemented as a pluggable library that any host application can “plug in” to gain the benefits of those processes. Preferably, the effort required to “plug in” the library is minimal, for example, a few lines of code in the host application to initialize the library and turn it on to begin managing second radio system 132B (e.g., Wi-Fi™ radio system). In addition, the library may be provided with an application programming interface (API) that comprises a number of methods for the host application to use to gain greater control over the functions of the library. For example, the API may provide a method that allows the host application to extract a list of hotspot locations, so that the host application can display a map of the available hotspot locations.

As an alternative, various embodiments of the disclosed processes may be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

In other words, those of skill in the art will appreciate that the various illustrative logical blocks, modules, circuits, and method steps described herein, and the embodiments disclosed herein can often be implemented as electronic hardware, computer software, or combinations of both. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit, or step is for ease of description. Specific functions or steps can be moved from one module, block, or circuit to another without departing from the invention.

In many mobile devices, it is customary to have the cellular radio system (e.g., first radio system 132A) on all the time. The cellular radio system handles communications with the mobile service provider, including voice calls and/or text messages. If there are no connections available via other radio connections, the cellular radio system may also handle any data communication that the mobile device may require. However, in many mobile devices, the data communication is automatically switched over to the Wi-Fi™ radio system (e.g., second radio system 132B) when a connection to the Internet or other backend system or network is available through the Wi-Fi™ radio system. This is because, in most cases, it is less costly and uses less battery power to send data communications over the Wi-Fi™ radio system. Some mobile devices may be equipped with a Wi-Fi™ radio system that is able to communicate with two or more access points (e.g., using different Wi-Fi™ protocols).

The mobile device (e.g., via application 134) may turn on the Wi-Fi™ radio system only in certain circumstances, for example, when a Wi-Fi™ access point is likely to be available. When the Wi-Fi™ radio system is turned on, it will scan the environment to see what, if any, Wi-Fi™ access points are reachable within the environment, and whether or not those Wi-Fi™ access points require a password or other credentials to establish a connection. If there is an access point available to the mobile device, the mobile device will connect to it, for example, to offload at least some wireless services (e.g., data communications, Short Message Service (SMS) communications, and/or voice communications) from the cellular network (e.g., primary network 122A) to the Wi-Fi™ network (e.g., alternative network 122B).

Examples of such radio management and/or alternative network access markets, in which such radio management is performed, may be found, for example, in U.S. Patent Pub. Nos. 2013/0322329, 2013/0322400, 2013/0322401, 2014/0293829, 2015/0189569, 2015/0189580, 2015/0189098, 2015/0282240, 2016/0192289, and 2016/0262201, the entireties of all of which are hereby incorporated herein by reference as if set forth in full. In embodiments of the alternative network access markets described in these references, a whitelist of hotspots (e.g., access points 124B) for alternative network 122B may be manually curated via server application 114 on platform 110.

In order to increase the available supply of amenity hotspots, beyond a manually-curated whitelist, an embodiment of client application 134 may be enabled to automatically discover, evaluate, and approve additional amenity hotspots on its own. Client application 134 may be configured to discover any open hotspot and/or only those hotspots which conform to specific guidelines. This enables the application to be configured with a level of aggressiveness based on a level of risk that a mobile network operator (MNO) or user deems acceptable. However, the ability to automatically approve hotspots, in conjunction with the multitude of existing hotspots, creates an issue of there being potentially millions of possible access point identifiers (e.g., Service Set Identifiers (SSIDs), Basic SSIDs (BSSIDs), Media Access Control (MAC) addresses, and/or the like) in the curated alternative network access market (e.g., stored in server database 116). Passing millions of access point identifiers to each client application 134 is not practical and would consume far too much time and data. Thus, in an embodiment, server application 114 only sends each client application 134 a minimal set of environment signatures, representing a compression of the millions of access point identifiers stored in server database 116. The environment signatures are sufficient to prime client application 134 with enough information to detect when a visible access point identifier may be included within the millions of access point identifiers stored in server database 116. While the access point identifiers will be primarily described herein as SSIDs, any other type of access point identifier may be used, and the identifiers may be unique or non-unique to an access point.

In an embodiment, server application 114 may maintain a list of one or more regular expressions. Client application 134 may control second radio system 132B to perform a scan to identify visible hotspots within the environment, resulting in a list of visible SSIDs. The application may then compare each SSID on the list of visible SSIDs to each of the one or more regular expressions, and only consider establishing a connection with a hotspot that has an SSID that matches at least one of the one or more regular expressions. Client application 134 may download the list of regular expression(s) from server application 114 and perform the regular-expression matching locally. Alternatively, client application 134 could transmit the list of visible SSIDs to server application 114, and server application 114 may perform the regular-expression matching and return the result (e.g., a list of visible SSIDs that match the regular expression, if any) to client application 134.

In an embodiment, in order to establish a premium opportunity (e.g., paid services), client application 134 of mobile device 130 must first send potential matches (i.e., visible SSIDs that match a regular expression representing permissible SSIDs) to server application 114. Server application 114 then applies market policies associated with mobile device 130 to determine whether or not the buyer (e.g., the MNO or user of mobile device 130) is willing to buy the premium services and the seller (e.g., operator of the hotspot associated with the matching SSID) is willing to sell the premium services. For example, if a scan by second radio system 132B identifies an SSID of “xfinitywifi,” which matches a regular expression representing permissible SSIDs, client application 134 can send this SSID in a request to server application 114 for a final determination. If server application 114 determines that the purchase of premium services from “xfinitywifi” is authorized, server application 114 may instruct client application 134 to connect to the hotspot represented by the “xfinitywifi” SSID. On the other hand, if server application 114 determines that the purchase is not authorized (e.g., at this time or location), server application 114 may instruct client application 134 to not connect to the hotspot. Essentially, for premium services, client application 134 performs an initial determination (e.g., using regular expressions), and server application 114 performs a final determination (e.g., using stored market policies).

Regular expressions are an improvement over listing each SSID individually, since they have the ability to match different SSIDs. For example, a restaurant chain, such as McDonald's™, may use SSIDs containing either the term “wayport” or “attwifi”, which can be easily combined into a single regular expression.

However, there is a need to support a massive number of SSIDs, since a single hotspot (e.g., amenity) provider may utilize thousands or millions of different SSIDs. Furthermore, in order to support a massive number of SSIDs, there is the need for a high-speed method of comparing a scan list of visible SSIDs to identify a match (e.g., using hashing or a binary search). The solution should be able to support both providers of amenity services (e.g., free services) and premium services (e.g., paid services), as well as pre-approved SSIDs and regular expressions defining a wide area Wi-Fi (WAW).

In an embodiment, a checksum is used to compress the SSID data. In this embodiment, server application 114 can send the checksums for a list of approved SSID signatures to client application 134. Then, if client application 134 encounters an SSID in its scan that matches one of the checksums, client application 134 may transmit an approval request, comprising the SSID to be approved, to server application 114. The approval request represents an on-the-spot request by client application 134 to server application 114 for a connection opportunity. Essentially, if client application 134 detects an SSID in the area, which it suspects is a connection opportunity because of the checksum match, client application 134 will send the SSID to server application 114 for a final determination, and server application 114 will instruct client application 134 to which SSID, if any, to connect.

In an embodiment, client application 134 requests environment signatures (e.g., checksum values) from server application 114, and server application 114 responds by transmitting environment signatures (e.g., one or more checksum values) to client application 134. The request message from client application 134 may comprise a “since” field (e.g., comprising a timestamp), and the response message from server application 114 may consist of only those environment signatures (e.g., checksum values) that are newer than the value of the “since” field.

An example request message that may be sent from client application 134 to server application 114 follows, wherein the ellipses represent other possible information and “1378310842” represents the timestamp value of the “since” field (labeled “sin” in the following):

```
“msg”:{
  ...
  “sin”:1378310842
  ...
}
```

An example response message that may be sent from server application 114 to client application 134 follows, wherein the ellipses represent other possible information and the “sigs” field comprises a list of checksum values:

```
“msg”:{
  ...
  “sigs”:[checksum1, checksum2, checksum3, ...]
  ...
}
```

Notably, checksum matching will not provide 100% positive matching between SSIDs detected by client application 134 and approved SSIDs. In other words, there will be instances in which a detected SSID is matched by the checksum without actually being an approved SSID, resulting in a false match. Thus, the environment signatures, described herein (e.g., checksum), represent a lossy compression method for permissible SSIDs.

In an embodiment, when client application 134 requests approval of a falsely-matched SSID, such that server application 114 denies the request, the falsely-matched SSID may be entered on a local blacklist on mobile device 130 (e.g., in local database 116). Thus, if client application 134 encounters the SSID again, while the SSID is on the local blacklist, client application 134 will ignore the SSID, i.e., not send another approval request despite the SSID matching via the checksum. This prevents unnecessary approval requests by rendering client application 134 “blind” to previously-denied SSIDs. The SSID's placement on the local blacklist may be temporary (e.g., twenty-four hours, one week, etc.) or permanent.

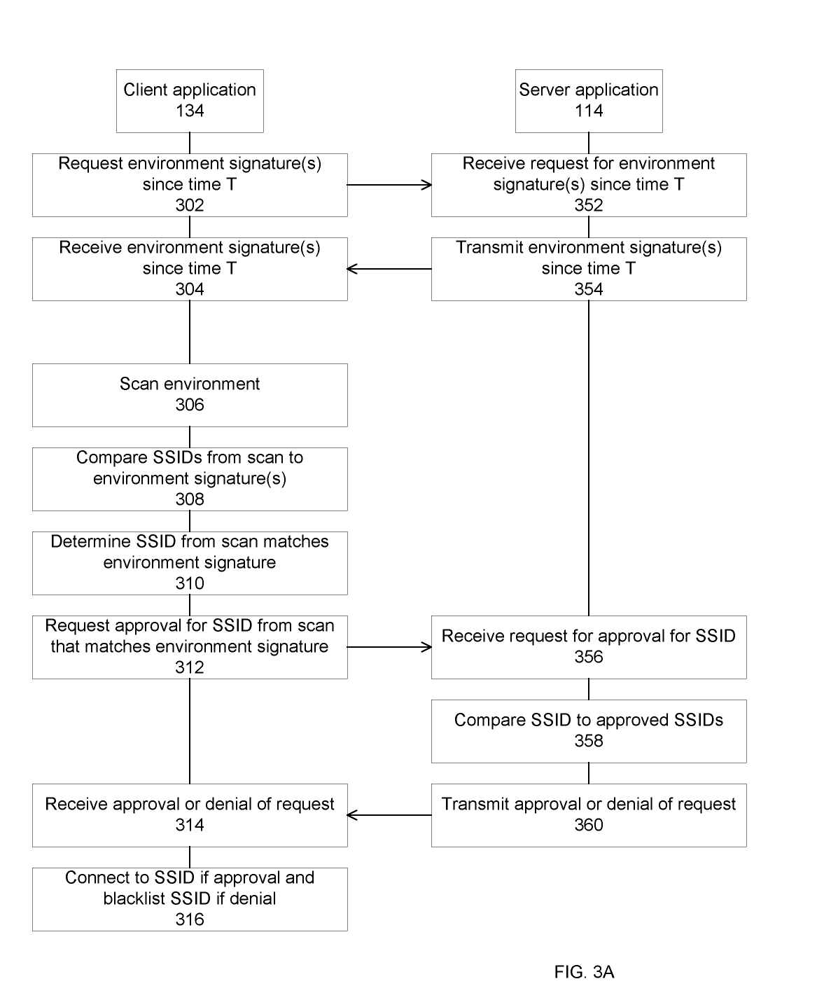

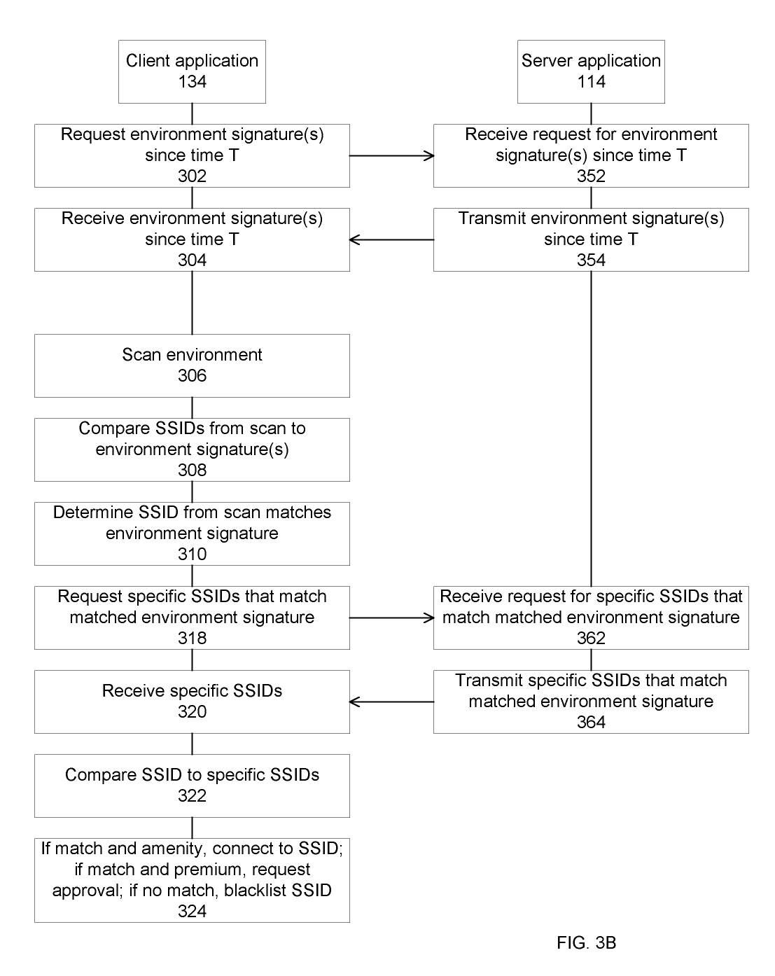

FIG. 3A illustrates the timings for the interactions between client application 134 and server application 114, when utilizing environment signatures, according to an embodiment. In step 302, client application 134 requests environment signatures since a time associated with the last received environment signature. In step 352, server application 114 receives this request and, in step 354, responds by transmitting all applicable environment signatures created since the time specified in the request. In step 304, client application 134 receives these environment signature(s).

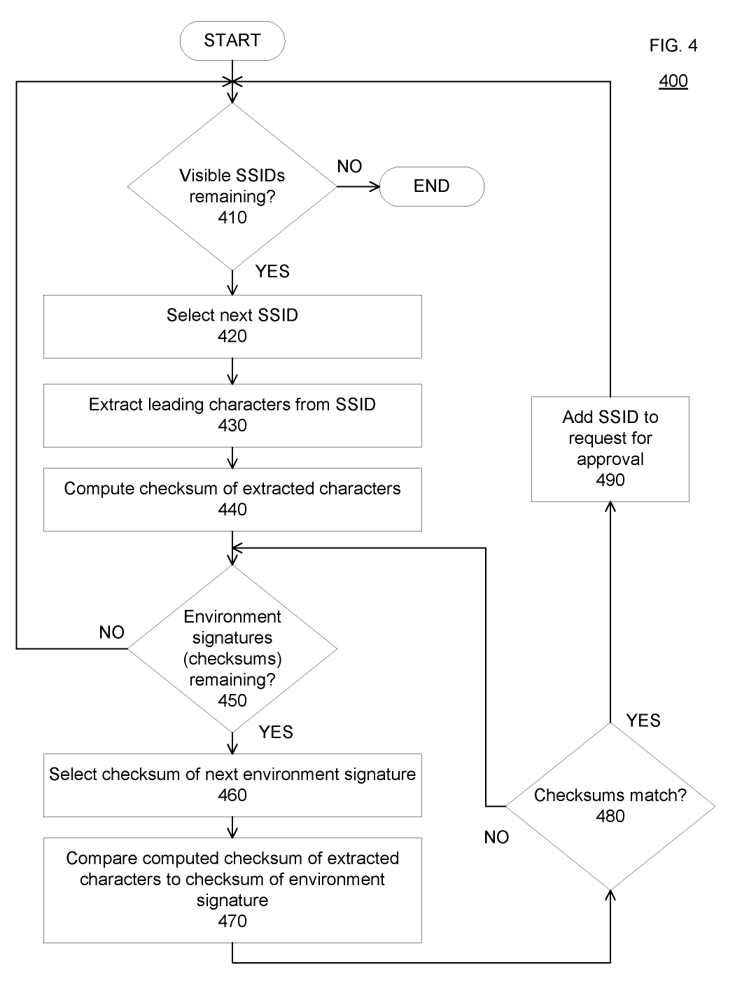

At some future time, in step 306, client application 134 scans the environment (e.g., using second radio system 132B) to identify visible SSIDs (e.g., identifying access points 124B). Then, in step 308, client application 134 compares the visible SSIDs to the environment signatures stored locally (e.g., in local database 136). Specifically, in an embodiment in which the environment signatures are checksum values, client application may, for each visible SSID, extract a predetermined number of leading characters from the SSID (e.g., twenty-two), compute a checksum value for the extracted characters, and compare the checksum value to the checksum values of each environment signature. An example implementation of step 308 is illustrated as process 400 in FIG. 4.

In step 310, client application 134 determines that one of the visible SSIDs matches an environment signature (e.g., the checksum value of the extracted leading characters of the visible SSID matches a checksum value of one of the environment signatures). In step 312, client application transmits an approval request, comprising the SSID matched in step 310, to server application 114.

In step 356, server application 114 receives the approval request comprising the matched SSID. In step 358, server application 114 compares the matched SSID to approved SSIDs (e.g., stored in database 116). In step 360, if the signature-matched SSID matches an approved SSID, server application 114 transmits an approval to client application 134. On the other hand, if the signature-matched SSID does not match an approved SSID, server application 114 transmits a denial to client application 134.

In step 314, client application 134 receives the approval or denial from server application 114. If an approval is received, client application 134 establishes a connection with the SSID. On the other hand, if a denial is received, client application 134 may blacklist the SSID either temporarily or permanently.

In an alternative embodiment, instead of client application 134 asking for approval from server application 114 for specific SSIDs as soon as those SSIDs are encountered, client application 134 may instead request all specific SSIDs for a particular environment signature. Specifically, if client application 134 encounters an SSID (e.g., from a scan of the environment) which matches a particular environment signature (e.g., previously received from server application 114), client application 134 may send a request to server application 114 for all SSIDs associated with that environment signature. In response to the request from client application 134, server application 114 may transmit a list of all SSIDs associated with the environment signature (or all SSIDs associated with the environment signature and within a predetermined distance of the current location of mobile device 130) to client application 134. Client application 134 may then compare the encountered SSID to the list of SSIDs received from server application 114, and only request approval for a connection (e.g., for premium services) from server application 114 if the encountered SSID matches an SSID in the list of SSIDs received from server application 114. In other words, client application performs a local pre-approval process before requesting approval from server application 114, in order to avoid unnecessary approval requests. Alternatively or additionally, client application 134 could automatically connect to the encountered SSID if it matches an SSID in the list of SSIDs received from server application 114, without requesting approval from server application 114 (e.g., for amenity services).

FIG. 3B illustrates the timings for the interactions between client application 134 and server application 114, when utilizing environment signatures, according to this alternative embodiment. Steps 302-310, 352, and 354 in FIG. 3B are identical to steps 302-310, 352, and 354, respectively, in FIG. 3A.

In step 318, client application transmits a request, for specific SSIDs that match the environment signature that matched a visible SSID in step 310, to server application 114. It should be understood that this request may comprise or otherwise identify the matched environment signature. In step 362, server application 114 receives the request for the specific SSIDs that match the environment signature that matched a visible SSID in step 310. In step 364, server application 114 responds by transmitting a list of specific approved SSID(s) that match the environment signature.

In step 320, client application 134 receives the list of specific approved SSIDs from server application 114. In step 322, client application 134 compares the visible SSID, matched in step 310, to the list of specific approved SSIDs. In step 324, if the visible SSID matches one of the specific approved SSIDs in the list and an amenity service is sought, client application 134 may automatically connect to the matched SSID. If the visible SSID matches one of the specific approved SSIDs in the list and a premium service is sought, client application 134 may request approval from server application 114 first, in a similar or identical manner to steps 312, 356, 358, 360, 314, and 316 in FIG. 3A. On the other hand, if the visible SSID does not match any of the specific approved SSIDs, client application 134 may blacklist the visible SSID, either temporarily or permanently.

In an embodiment, the checksum function used for the lossy compression extracts a fixed number (e.g., sixteen) of the leading characters of an SSID and sums each byte value for each character together. Furthermore, the characters may be weighted in the checksum value according to their position in the extracted character string. For example, the byte value of each character may be multiplied by its position in the extracted character string (e.g., beginning with one for the first character and sixteen for the sixteenth character). Weighting the characters in this manner prevents, for example, a character string of “AB” erroneously matching the character string “BA”.

FIG. 4 illustrates a process 400 of comparing SSIDs to environment signatures, according to an embodiment that utilizes checksum values as the lossy compression. Process 400 may correspond to step 308 in each of FIGS. 3A and 3B, and may be executed by client application 134.

In step 410, client application 134 determines whether any visible SSIDs (e.g., from the scan of the environment performed in step 306 of FIG. 3A or 3B) remain to be considered. If no visible SSIDs remain to be considered (i.e., “NO” in step 410), process 400 ends. On the other hand, if at least one visible SSID remains to be considered, the next visible SSID to be considered is selected in step 420.

In step 430, client application 134 extracts a predetermined number of leading characters (e.g., the first twenty-two characters) from the SSID selected in step 420.

In step 440, client application 134 computes the checksum of the leading characters, extracted in step 430. It should be understood that the checksum algorithm used in step 440 should be the same as the checksum algorithm used to compute the environment signatures (e.g., by server application 114). Advantageously, in the illustrated process 400, the checksum is only computed once for each visible SSID.

In step 450, client application 134 determines whether any environment signatures or checksum values remain to be considered. If all checksum values have been considered (i.e., “NO” in step 450), process 400 returns to step 410. On the other hand, if at least one checksum value remains to be considered (i.e., “YES” in step 450), the next checksum value to be considered is selected in step 460.

In step 470, client application 134 compares the checksum, computed from the extracted leading characters in step 440, to the checksum of the environment signature selected in step 460, and, in step 480, determines whether or not the compared checksums are a match. If the checksums do not match (i.e., “NO” in step 480), process 400 returns to step 450. On the other hand, if the checksums match (i.e., “YES” in step 480), process 400 proceeds to step 490.

In step 490, the matched SSID may be added to an approval request, which will be sent to server application 114. This approval request may correspond to the approval request sent by client application 134 in step 312 of FIG. 3A. Following step 490, process 400 returns to step 410.

It should be understood that one or more of the steps, described with respect to process 400, may be rearranged without changing the function of process 400. For example, the inner loop defined by step 450 and the outer loop defined by step 410 could be reversed. Notably, however, this would result in the checksums for the visible SSIDs being computed redundantly. As another alternative, following step 490, process 400 could return to step 450 to identify all matching environment signatures, instead of just the first matching environment signature.

An embodiment which extracts the leading sixteen characters of an SSID for the checksum results in a maximum checksum value of 34680. To fit within an integer, fifteen characters can be extracted, which results in a maximum value of 30600. As other examples, twenty-seven characters can be extracted to fit within five characters (i.e., up to 99999), and eight characters can be extracted to fit within four characters (i.e., up to 9999). Note that the number of extracted characters will generally not exceed thirty-two characters, since thirty-two characters is the maximum length of an SSID.

It should be understood that the smaller the number of leading characters that are extracted for the checksum, the more false positives that will occur. The following table lists, for some possible numbers of leading characters extracted, the maximum checksum value, the checksum length (important for transport to client application 134), and the total transport size required to send the maximum number of checksums (i.e., the maximum checksum*the length of the maximum checksum) using JSON from server application 114 to client application 134. In an embodiment, an unsigned integer may be used as a target for the checksum. In this case, the checksum is optimally derived from the leading twenty-two characters of each SSID.

| SSID Character Length | Max Checksum | Length | Transport (KB) |
|---|---|---|---|
| 8 | 9180 | 4 | 36 |
| 15 | 30600 | 5 | 150 |
| 22 | 64515 | 5 | 316 |
| 27 | 96390 | 5 | 471 |
| 32 | 134640 | 6 | 789 |

In an embodiment, the checksum algorithm breaks down an SSID string into bytes, rather than UTF-8 values. The code, which may correspond to steps 430 and 440 in process 400 of FIG. 4, may be implemented as follows:

```
public Long getSsidCode(String ssid)
{
  Long ssidCode = 0l;
  byte[ ] bytes = ssid.getBytes( );
  Integer length = bytes.length;
  if (length > 22) length = 22;
  for (Integer index = 0; index < length; index++)
  {
    ssidCode += ((long) (bytes[index] & 0xff)) * (((long) index) + 1l);
  }
  return ssidCode;
}
```

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A method for a mobile device comprising a first radio system and a second radio system, the method comprising using at least one hardware processor of the mobile device to:
receive one or more environment signatures from a server application;
use the second radio system to scan an environment of the mobile device to determine one or more visible access point identifiers; and,
for each of the one or more visible access point identifiers,
compute a signature from the visible access point identifier, and
compare the computed signature to each of the one or more environment signatures.

2. The method of claim 1, wherein each access point identifier comprises a Service Set Identifier (SSID).

3. The method of claim 1, further comprising using the at least one hardware processor to:
for each of the one or more visible access point identifiers, when the computed signature matches at least one of the one or more environment signatures, add the visible access point identifier to an approval request; and,
when the approval request comprises at least one of the one or more visible access point identifiers, send the approval request to the server application.

4. The method of claim 3, further comprising using the at least one hardware processor to:
receive an approval response to the approval request from the server application; and,
when the approval response identifies at least one of the one more visible access point identifiers, establish a connection to an access point identified by that at least one access point identifier.

5. The method of claim 4, further comprising using the at least one hardware processor to, when the approval response indicates that an access point identifier that was included in the approval request is not approved, add that unapproved access point identifier to a blacklist, such that no signature will be computed and no comparison to the one or more environment signatures will be performed for that unapproved access point identifier for at least a predetermined time period and that unapproved access point identifier will not be added to any approval request for at least the predetermined time period.

6. The method of claim 5, further comprising using the at least one hardware processor to delete each unapproved access point identifier from the blacklist once that unapproved access point identifier has remained in the blacklist for the predetermined time period.

7. The method of claim 1, further comprising using the at least one hardware processor to:
for each of the one or more visible access point identifiers, when the computed signature matches at least one of the one or more environment signatures, add the at least one environment signature to a request;
when the request comprises at least one environment signature, send the request to the server application;
in response to the request, receive a list of approved access point identifiers, that match the at least one environment signature, from the server application; and
compare at least one of the one or more visible access point identifiers to the list of approved access point identifiers.

8. The method of claim 7, further comprising using the at least one hardware processor to, when at least one of the one or more visible access point identifiers matches an access point identifier in the list of approved access point identifiers, establish a connection to an access point identified by the at least one access point identifier.

9. The method of claim 7, further comprising using the at least one hardware processor to, when at least one of the one or more visible access point identifiers matches an access point identifier in the list of approved access point identifiers:
when a free service is available from an access point identified by the at least one access point identifier, establish a connection to the access point; and,
when only a paid service is available from the access point identified by the at least one access point identifier,
request approval from the server application to establish a connection to the access point,
receive a response to the request from the server application, and,
when the response approves the request, establish a connection to the access point.

10. The method of claim 9, further comprising using the at least one hardware processor to, for each of the one more visible access point identifiers that does not match any access point identifier in the list of approved access point identifiers, add that visible access point identifier to a blacklist, such that no signature will be computed and no comparison to the one or more environment signatures will be performed for that visible access point identifier for at least a predetermined time period.

11. The method of claim 9, further comprising using the at least one hardware processor to, when the response does not approve the request, add the at least one access point identifier to a blacklist, such that no signature will be computed and no comparison to the one or more environment signatures will be performed for that at least one access point identifier for at least a predetermined time period.

12. The method of claim 11, further comprising using the at least one hardware processor to delete the at least one access point identifier from the blacklist once the at least one access point identifier has remained in the blacklist for the predetermined time period.

13. The method of claim 1, wherein each of the one or more environment signatures comprises a lossy compression of a plurality of access point identifiers.

14. The method of claim 13, wherein each of the one or more environment signatures comprises a checksum value, and wherein, for each of the one or more visible access point identifiers, computing the signature from the visible access point identifiers comprises:
extracting a predetermined number of characters from the visible access point identifier; and
computing a checksum value of the extracted characters to generate the computed signature.

15. The method of claim 14, wherein extracting a predetermined number of characters from the visible access point identifier comprises extracting a leading twenty-two characters from the visible access point identifier.

16. The method of claim 14, wherein computing a checksum value of the extracted characters comprises weighting each extracted character according to its position in the extracted characters.

17. The method of claim 16, wherein weighting each extracted character according to its position comprises multiplying a byte value of the extracted character by its numerical position in the extracted characters.

18. The method of claim 1, further comprising using the at least one hardware processor to:
send a request to the server application, wherein the request indicates a time at which the one or more environment signatures were last updated;
in response to the request, receive a server update of environment signatures from the server application, wherein the server update comprises updates of environment signatures since the time at which the one or more environment signatures were last updated; and
update the one or more environment signatures based on the server update.

19. A mobile device comprising:
a first radio system;
a second radio system;
at least one hardware processor; and
one or more software modules configured to, when executed by the at least one hardware processor,
receive one or more environment signatures from a server application,
use the second radio system to scan an environment of the mobile device to determine one or more visible access point identifiers, and,
for each of the one or more visible access point identifiers,
compute a signature from the visible access point identifier, and
compare the computed signature to each of the one or more environment signatures.

20. A non-transitory computer-readable medium having instructions stored therein, wherein the instructions, when executed by a processor of a mobile device comprising a first radio system and a second radio system, cause the processor to:
receive one or more environment signatures from a server application;
use the second radio system to scan an environment of the mobile device to determine one or more visible access point identifiers; and,
for each of the one or more visible access point identifiers,
compute a signature from the visible access point identifier, and
compare the computed signature to each of the one or more environment signatures.
